(19) United States
(12) Patent Application Publication
(10) Pub. No.: US 2026/0072485 A1
(43) Pub. Date: Mar. 12, 2026

(54) DUAL-MODE POWER SUPPLY UNIT

(71) Applicant: LENOVO GLOBAL TECHNOLOGY (UNITED STATES) INC., MORRISVILLE, NC (US)

(72) Inventors: WEI-TIEN CHEN, TAIPEI CITY (TW); JEFFREY S HOLLAND, MORRISVILLE, NC (US)

(21) Appl. No.: 18/826,584

(22) Filed: Sep. 6, 2024

(51) Int. Cl. G06F 1/20; G06F 1/26; G06F 11/07

(52) U.S. Cl. CPC G06F 1/20; G06F 1/26; G06F 11/0781; G06F 2200/201

(57) ABSTRACT

Methods, systems, and apparatuses may include an immersion tank; a computing system positioned within the immersion tank; and a power supply unit (PSU) positioned within the immersion tank, wherein the PSU comprises: a power supply chassis; one or more fans positioned within the power supply chassis; and a sensor positioned within the power supply chassis, wherein the sensor is configured to, upon detecting a liquid within the power supply chassis, change a power supply mode of the PSU from an air-cooled mode to an immersion-cooled mode.

### BACKGROUND

The present disclosure relates to methods, apparatuses, and systems for changing a mode of a power supply unit.

### SUMMARY

Methods, systems, and apparatuses for changing a mode of a power supply unit according to various embodiments are disclosed in this specification. In accordance with one aspect of the present disclosure, a method of changing a mode of a power supply unit includes detecting, by a sensor included within a power supply unit (PSU), a liquid within the PSU; and changing, by the PSU, a power supply mode from an air-cooled mode to an immersion-cooled mode.

In accordance with another aspect of the present disclosure, changing a mode of a power supply unit may include a system including: an immersion tank; a computing system positioned within the immersion tank; and a power supply unit (PSU) positioned within the immersion tank, wherein the PSU comprises: a power supply chassis; one or more fans positioned within the power supply chassis; and a sensor positioned within the power supply chassis, wherein the sensor is configured to, upon detecting a liquid within the power supply chassis, change a power supply mode of the PSU from an air-cooled mode to an immersion-cooled mode.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example block diagram of a system for changing a mode of a power supply unit in accordance with embodiments of the present disclosure.

FIG. 2 shows an example block diagram of a power supply unit configured for changing a mode of a power supply unit in accordance with embodiments of the present disclosure.

FIG. 3 is a flowchart of an example method of changing a mode of a power supply unit according to some embodiments of the present disclosure.

FIG. 4 is a flowchart of an example method of changing a mode of a power supply unit according to some embodiments of the present disclosure.

### DETAILED DESCRIPTION

A power supply unit (PSU) converts AC voltage to low-voltage regulated DC power for computing components. The temperature of a PSU must be maintained to prevent the PSU from experiencing performance issues. Some PSUs have included fans that help to cool the PSU in an air-cooled environment, while other PSUs may be cooled by being placed in an immersion tank full of inert (non-conductive) liquid coolant. A typical air-cooled PSU, especially one with included fans, cannot properly operate in an immersion-cooled environment, at least because the liquid coolant can slow down the fans, which can in turn cause errors that may shut down the power supply or otherwise negatively affect the operation of the PSU. The embodiments of the present disclosure describe a PSU that is configured to operate in both an air-cooled environment and an immersion-cooled environment.

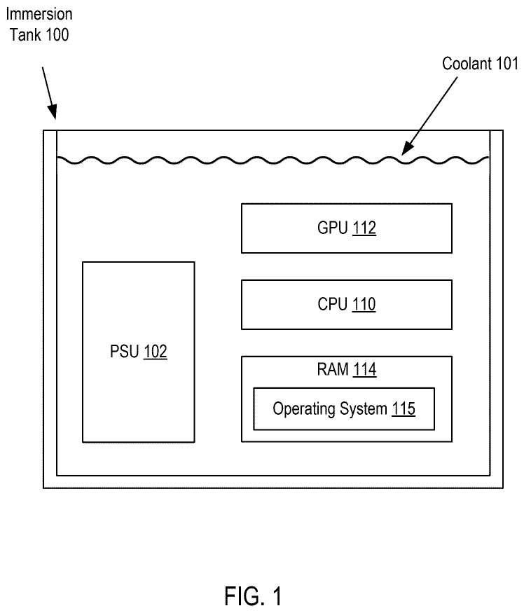

Exemplary methods, systems, and apparatuses for changing a mode of a power supply unit in accordance with the present disclosure are described with reference to the accompanying drawings, beginning with FIG. 1. FIG. 1 sets forth an example block diagram of a system for changing a mode of a power supply unit in accordance with embodiments of the present disclosure. FIG. 1 shows an immersion tank 100 full of liquid coolant (such as coolant 101), and contains a PSU 102, and computing components, such as a central processing unit (CPU) 110, a graphics processing unit (GPU) 112, and random-access memory (RAM) 114 (which may include, e.g., an operating system 115). The PSU 102 is configured to supply operating power to the CPU 110, GPU 112, and RAM 114. In some embodiments, the PSU 102 and the computing components may be included within a single computing system (e.g., a server) or within a housing or chassis thereof installed or placed in the immersion tank 100. In some embodiments, the PSU 102 may be configured to provide operating power to a plurality of separate computing systems (and the computing components thereof), with each separate computing system installed or placed within the immersion tank 100. In some embodiments, the PSU 102 may be configured to provide operating power to a computing system (and the computing components thereof that is installed or placed outside of the immersion tank 100. The computing components of FIG. 1 are merely illustrative examples, and other systems implementing the inventive concepts disclosed herein may include other computing components, different numbers of computing components, and so on.

The example coolant 101 of FIG. 1 is configured to cool the computing components included within the immersion tank (such as the PSU 102, the CPU 110, etc.). In the example of FIG. 1, the components are fully submerged in the coolant 101. In another embodiment, one or more of the components (such as the CPU, PSU, etc.) may be only partially submerged in the coolant 101. The coolant 101 is configured to be thermally conductive and electrically insulating, such as a dielectric liquid. The coolant 101 may be circulated through the immersion tank 100 to cool down the components included within the tank. Such circulation of coolant through the immersion tank 100 may be carried out by ports in the immersion tank 100, fluid lines connected to the ports, pumps connected to the fluid lines, or the like. The circulation components are not shown in FIG. 1.

The example PSU 102 of FIG. 1 is configured to be operable and to operate in both an immersion-cooled environment (as shown in FIG. 1) or in an air-cooled environment (not shown in FIG. 1) without requiring reconfiguration or modification of the PSU 102 (e.g., without changing a firmware or setting of the PSU 102). For example, the PSU 102 of FIG. 1 is configured to maintain operation (e.g., supplying power to other components) whether the PSU 102 is installed in an air-cooled environment or in an immersion-cooled environment without interrupting or otherwise affecting PSU performance. In one embodiment, a power supply mode of the PSU 102 may be changed based on detecting an environment in which the PSU 102 is installed. For example, the PSU 102 may be configured to automatically select between an air-cooled mode and an immersion-cooled mode, based on detecting whether the environment in which the PSU 102 is installed is an air-cooled environment or an immersion-cooled environment.

When operating in the air-cooled mode, the PSU 102 having one or more fans will operate with the fans running to aid in cooling the PSU 102. However, as discussed above, the fans within the PSU 102 that are configured to help cool the PSU while it is in an air-cooled environment cannot properly operate while submerged in liquid (such as in an immersion-cooled environment). For example, the PSU fans would be slowed down by the liquid coolant 101 that the PSU 102 is submerged in, which could cause one or more errors within the PSU (such as a fan speed error). The errors caused by the improperly functioning fans could potentially affect PSU performance or even cause the PSU to shut down. Accordingly, when operating the in the immersion-cooled mode, the PSU 102 may suppress or disregard errors associated with the PSU fans, allowing the PSU 102 to continue operating without being affected by such errors. Further, the PSU fans may be turned off or disabled when the PSU 102 operates in the immersion-cooled mode, thereby reducing the power used by the PSU 102 and avoiding potential movement, flow, or turbulence of the coolant 101, since the fans are no longer needed in such an environment.

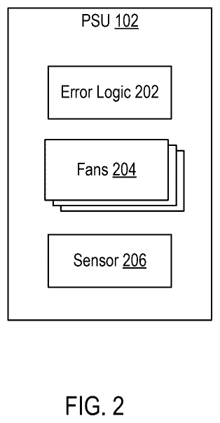

Although fan functioning is discussed above, the present disclosure is not limited thereto, and in some embodiments, errors and/or operation of other components within the PSU 102 could additionally, or alternatively, be managed (e.g., enabled, disabled, suppressed) and so on based on whether the PSU 102 is operating in an air-cooled environment or in an immersion-cooled environment. As described in greater detail below, the PSU 102 is configured to detect what environment the PSU is in (see FIG. 2 for more detail).

In some embodiments, the PSU 102 may be initially configured to operate in a first mode or default mode (e.g., in the air-cooled mode corresponding to the air-cooled environment), and based on the PSU 102 detecting that the PSU 102 is in a second environment, may switch from operating in the first mode to operating in a second mode (e.g., in the immersion-cooled mode corresponding to the immersion-cooled environment). In some embodiments, the PSU 102 may be configured to, in response to detecting an immersion-cooled environment is present, ensure that an air-cooled power supply mode is disabled and that an immersion-cooled power supply mode is enabled. In some embodiments, the PSU 102 may be configured to detect a change in an installation environment and may switch the operating mode thereof in response to detecting the change in the installation environment. For example, the PSU 102 may be removed from the immersion tank 100 or the coolant 101 may be partially or completely removed or drained from the immersion tank 100 (e.g., for maintenance). In response thereto, the PSU 102 may be configured to perform periodic detection of the current installation environment, and switch between the immersion-cooled mode and the air-cooled mode. In this way, PSU 102 may be able continue to operate and supply operating power while switching cooling modes to match any changes in installation environment. In some embodiments, a notification may be sent (e.g., to an external destination, such as a remote monitoring system or controller) when entering a cooling mode and/or when switching cooling modes. The notification may include an indication of what mode the PSU is entering or switching to, and the notification may be stored in memory (either local to the PSU or remote to the PSU) or sent over a network to another computing device or component for storage.

For further explanation, FIG. 2 sets forth an example block diagram of a power supply unit configured for changing a mode of a power supply unit in accordance with embodiments of the present disclosure. FIG. 2 includes error logic 202, one or more fans 204, and a sensor 206 within the chassis of the PSU 102. The example fans 204 are configured to cool the PSU while in an air-cooled environment. In some embodiments, the fans 204 may include controllers (not shown) or be controlled by an external controller (204) to control operating characteristics of the fans (e.g., operating speed). The example error logic 202 is configured to generate errors based on the monitoring (by the PSU) of various components of the PSU, including the fans 204. For example, if the PSU detects that a fan is operating below its expected speed or performance, the error logic 202 may generate an error associated with the fan. The error logic 202 may maintain one or more error logs and store an entry in the log each time an error is generated. The errors, or the error logs, may be stored or sent to a computing component coupled to the PSU or to a computing system remote to the PSU.

The error logic 202 of FIG. 2 may be also configured to suppress generation of one or more errors. In one embodiment, the error logic 202 is configured to determine whether or not to generate an error based on what mode the PSU is currently in. For example, the error logic 202 may determine whether to generate an error associated with a fan based on whether the PSU is in an air-cooled mode or an immersion-cooled mode. For example, the error logic 202 may determine to suppress the generation of an error associated with a fan in the PSU (despite monitoring data indicating a fan is performing outside an expected threshold level) based on the PSU operating in an immersion-cooled mode. In such an example, any errors associated with PSU fans are not generated by the error logic. In another embodiment, the error logs associated with the fans are disabled.

The example sensor 206 is configured to detect a presence of liquid or coolant within the PSU. The example sensor 206 of FIG. 2 may be any type of sensor configured to detect the presence of a liquid within the PSU. In one embodiment, the sensor may be a standard fluid detector (e.g., a leak detector), having two wires. In such a sensor, when liquid contacts the sensor 206, the liquid completes the circuit between the two wires and causes the sensor to detect the liquid. In such an embodiment, the liquid coolant may not be inert. In some embodiments, the sensor may be configured to generate a value indicating a pressure, resistance, capacitance, humidity, moisture, and/or other property of an environment local to the sensor 206, and compare the generated value with a threshold specific to the property. As a result of the comparison (e.g., if the pressure is above or below the threshold), the sensor 206 may be able to detect the presence or absence of liquid within the PSU. In some embodiments, the sensor 206 may not require direct contact between the sensor 206 and any liquid or coolant. For example, in an embodiment where the sensor 206 is positioned above the bottom of the PSU, the liquid may take some time to reach the sensor. A humidity sensor present within the PSU may be configured to detect the presence of liquid within the PSU without having to wait for the liquid (such as the coolant in the immersion tank) to reach and directly contact the sensor.

The PSU 102 is configured to change the cooling mode of the PSU based on whether or not the sensor is detecting liquid in the PSU. In one embodiment the sensor within the PSU is configured to periodically turn on the sensor 206 or check the state of the sensor 206 to determine whether the sensor 206 still detects liquid in the PSU. In such an embodiment, the time interval between operation of the sensor may be predetermined or may be set based on a user input. In another embodiment, the sensor is configured to operate continuously and continually provide an up-to-date indication of whether or not liquid is present within the PSU.

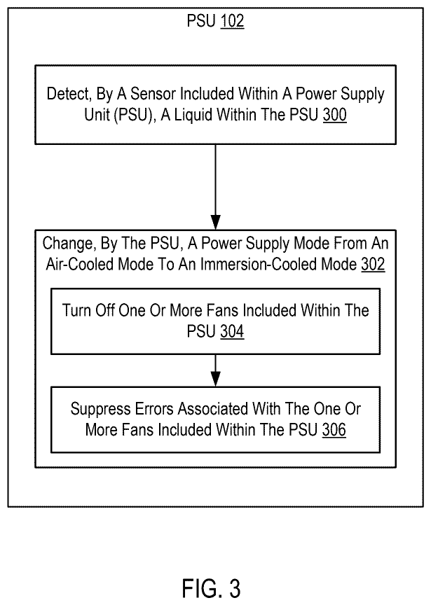

For further explanation, FIG. 3 sets forth a flowchart of an example method of changing a mode of a power supply unit according to some embodiments of the present disclosure. The method of FIG. 3 includes detecting 300, by a sensor included within a PSU, a liquid within the PSU. Detecting 300 a liquid within the PSU may be carried out by a sensor included within the PSU, as described above.

The method of FIG. 3 further includes changing 302, by the PSU, a power supply mode from an air-cooled mode to an immersion-cooled mode. Changing 302 the power supply mode may be carried out automatically by the PSU in response to detecting the liquid, including altering one or more settings or components within the PSU. The method of FIG. 3 further includes, as part of changing 302 a power supply mode, turning off 304 one or more fans included within the PSU. Turning off 304 one or more fans within the PSU may be carried out by e.g., setting the pulse width modulation (PWM) to zero for the one or more fans that are being turned off. In one embodiment, the PSU may turn off all of the fans in the PSU in response to detecting liquid by a single sensor. In another embodiment, where the PSU has multiple sensors, with each sensor positioned proximate to each fan (such as at the same level as, or coupled to, each fan), the PSU is configured to turn off only the fans for which liquid is detected. In such an embodiment, if the PSU is in an immersion-cooled environment and only partially submerged in the liquid coolant, only the fans that are within the coolant, and therefor unable to operate properly, are turned off in response to detecting which fans are submerged in liquid.

The method of FIG. 3 further includes, as part of changing 302 a power supply mode, suppressing generation of 306 errors associated with the one or more fans included within the PSU. Suppressing 306 errors associated with the one or more fans included within the PSU may be carried out by the PSU disabling warning/fault logs associated with the one or more fans. In one embodiment, errors associated with the one or more fans are prevented from being logged or recorded. In another embodiment, any errors associated with the one or more fans are intercepted and stopped from reaching their intended target. In one embodiment, the PSU may suppress errors associated with all of the fans in the PSU in response to detecting liquid by a single sensor. In another embodiment, where the PSU has multiple sensors, with each sensor positioned proximate to each fan (such as at the same level as, or coupled to, each fan), the PSU is configured to suppress errors associated with only the fans for which liquid is detected. In such an embodiment, if the PSU is in an immersion-cooled environment and only partially submerged in the liquid coolant, only the fans that are within the coolant, and therefor unable to operate properly, have their errors suppressed in response to detecting which fans are submerged in liquid.

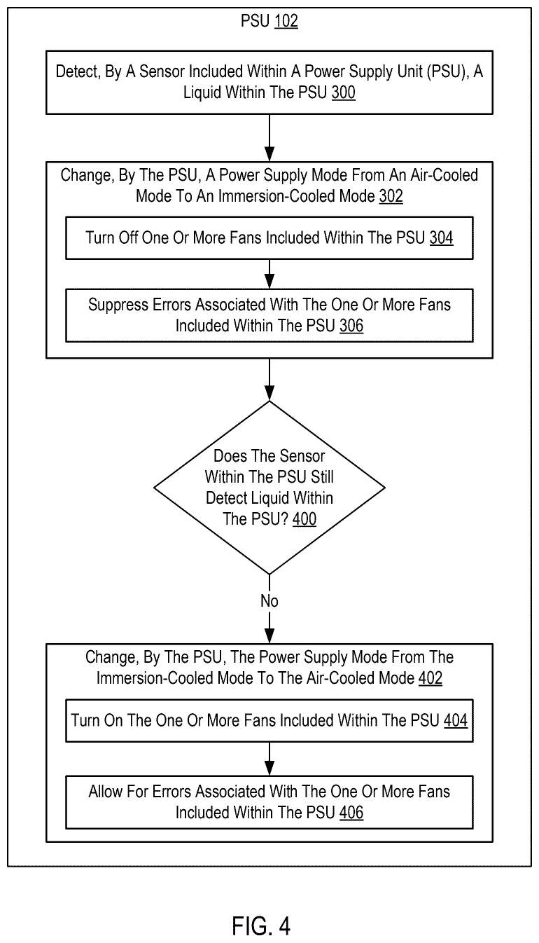

For further explanation, FIG. 4 sets forth a flowchart of another example method of changing a mode of a power supply unit according to some embodiments of the present disclosure. The method of FIG. 4 differs from the method of FIG. 3 in that the method of FIG. 4 further includes determining 400 whether the sensor within the PSU still detects liquid within the PSU. Determining 400 whether the sensor within the PSU still detects liquid within the PSU may be carried out by periodically turning on the sensor or checking the state of the sensor to determine whether the sensor still detects liquid in the PSU. In another embodiment, the sensor is operating continuously and providing an up to date indication of whether or not liquid is present within the PSU.

The method of FIG. 4 further includes changing 402, by the PSU, a power supply mode from an immersion-cooled mode to an air-cooled mode. Changing 402 the power supply mode may be carried out automatically by the PSU in response to detecting the liquid, including altering one or more settings or components within the PSU. The method of FIG. 4 further includes, as part of changing 402 a power supply mode, turning back on 404 the one or more fans included within the PSU. Turning back on 404 one or more fans within the PSU may be carried out by setting the pulse width modulation (PWM) to a value higher than zero for the one or more fans that are being turned off. In one embodiment, the PSU may turn on all of the fans in the PSU in response to a single sensor detecting that there is not liquid present at the sensor within the PSU. In another embodiment, where the PSU has multiple sensors, with each sensor positioned proximate to each fan (such as at the same level as, or coupled to, each fan), the PSU is configured to turn on only the fans for which liquid is no longer detected. In such an embodiment, if the PSU is in an immersion-cooled environment with the liquid draining and one or more fans have emerged out of the coolant, only the fans that are no longer within the coolant are turned back on in response to detecting which fans are no longer submerged in liquid.

The method of FIG. 4 further includes, as part of changing 402 a power supply mode, allowing 406 for errors associated with the one or more fans included within the PSU. Allowing for 406 errors associated with the one or more fans included within the PSU may be carried out by the PSU enabling warning/fault logs associated with the one or more fans. In one embodiment, errors associated with the one or more fans are allowed to be logged or recorded. In one embodiment, the PSU is configured to allow for errors associated with any of the fans in the PSU in response to a single sensor detecting that there is no longer liquid within the PSU. In another embodiment, where the PSU has multiple sensors, with each sensor positioned proximate to each fan (such as at the same level as, or coupled to, each fan), the PSU is configured to allow for errors associated only with the fans for which liquid is no longer detected. In such an embodiment, if the PSU is in an immersion-cooled environment with the liquid draining and one or more fans have emerged out of the coolant, only the fans that are no longer within the coolant will be able to log errors in response to detecting which fans are no longer submerged in liquid.

In view of the explanations set forth above, readers will recognize that the benefits of changing a mode of a power supply unit according to embodiments of the present disclosure include:
Increasing PSU performance by allowing for a PSU that can select a cooling mode based on a detected cooling environment, or switch a cooling mode from among different cooling modes based on a detected cooling environment without halting or affecting performance, and without turning off the PSU.

The flowchart and block diagrams in the Figures illustrate the architecture, functionality, and operation of possible implementations of systems, methods, and apparatuses according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method comprising:
detecting, by a sensor included within a power supply unit (PSU), a presence of a liquid within the PSU; and
changing, by the PSU, a power supply mode from a default air-cooled mode to an immersion-cooled mode in response to the detecting of the liquid within the PSU.

2. The method of claim 1, wherein changing to the immersion-cooled mode includes turning off one or more fans included within the PSU.

3. The method of claim 1, wherein changing to the immersion-cooled mode includes suppressing generation of errors associated with one or more fans included within the PSU.

4. The method of claim 1, further comprising detecting, by the sensor, that the liquid is no longer present within the PSU, and changing, by the PSU and based on the sensor no longer detecting the presence of the liquid, the power supply mode from the immersion-cooled mode to the air-cooled mode.

5. The method of claim 4, wherein changing to the air-cooled mode includes turning on one or more fans included within the PSU.

6. The method of claim 4, wherein changing to the air-cooled mode includes enabling generation of errors associated with one or more fans included within the PSU.

7. The method of claim 1, wherein changing the power supply mode from the air-cooled mode to the immersion-cooled mode occurs without interrupting operation of the PSU.

8. A power supply unit (PSU) comprising:
a power supply chassis;
one or more fans positioned within the power supply chassis; and
a sensor positioned within the power supply chassis, wherein the sensor is configured to, upon detecting a liquid within the power supply chassis, ensure that an air-cooled power supply mode of the PSU is disabled and that an immersion-cooled power supply mode of the PSU is enabled.

9. The PSU of claim 8, wherein in the immersion-cooled power supply mode, the one or more fans of the PSU are disabled, and in the air-cooled power supply mode, the one or more fans of the PSU are enabled.

10. The PSU of claim 8, wherein in the immersion-cooled power supply mode errors associated with the one or more fans are suppressed and not generated by the PSU, and in the air-cooled power supply mode, the errors associated with the one or more fans are generated by the PSU.

11. The PSU of claim 8, wherein the sensor is further configured to, when the liquid is no longer detected within the power supply chassis, change a mode of operation of the PSU such that the air-cooled power supply mode is enabled and that the immersion-cooled power supply mode is disabled.

12. The PSU of claim 11, wherein in the immersion-cooled power supply mode, the one or more fans of the PSU are disabled, and in the air-cooled power supply mode, the one or more fans of the PSU are enabled.

13. The PSU of claim 11, wherein in the immersion-cooled power supply mode errors associated with the one or more fans are suppressed and not generated by the PSU, and in the air-cooled power supply mode, the errors associated with the one or more fans are generated by the PSU.

14. The PSU of claim 11, wherein changing the power supply mode from the immersion-cooled mode to the air-cooled mode occurs without interrupting a power supply operation of the PSU.

15. A system comprising:
an immersion tank;
a computing system positioned within the immersion tank; and
a power supply unit (PSU) positioned within the immersion tank, wherein the PSU comprises:
a power supply chassis;
one or more fans positioned within the power supply chassis; and
a sensor positioned within the power supply chassis, wherein the sensor is configured to, upon detecting a liquid within the power supply chassis, change a power supply mode of the PSU from a default air-cooled mode to an immersion-cooled mode.

16. The system of claim 15, wherein changing to the immersion-cooled mode includes turning off the one or more fans.

17. The system of claim 15, wherein changing to the immersion-cooled mode includes suppressing errors associated with the one or more fans.

18. The system of claim 15, wherein the sensor is further configured to, when the liquid is no longer detected within the power supply chassis, change the power supply mode from the immersion-cooled mode to the air-cooled mode.

19. The system of claim 18, wherein changing to the air-cooled mode includes turning on the one or more fans.

20. The system of claim 18, wherein changing to the air-cooled mode includes enabling generation of errors associated with the one or more fans.
